(19) United States
(12) Patent Application Publication
(10) Pub. No.: US 2026/0192812 A1
(43) Pub. Date: Jul. 9, 2026

(54) FAILOVER METHOD BASED ON REDUNDANT SERVICE AND VEHICLE

(71) Applicants: Hyundai Motor Company, Seoul (KR); Kia Corporation, Seoul (KR)

(72) Inventors: In Sub SONG, Hwaseong-Si (KR); Woo Tae JEON, Hwaseong-Si (KR); Woo Kyung JUNG, Hwaseong-Si (KR); Tae Ho HAN, Hwaseong-Si (KR)

(21) Appl. No.: 19/392,745

(22) Filed: Nov. 18, 2025

(30) Foreign Application Priority Data
Dec. 13, 2024 (KR) 10-2024-0185978

(51) Int. Cl. B60W 50/029; B60W 50/02

(52) U.S. Cl. CPC B60W 50/029; B60W 50/0205; B60W 2050/0292; B60W 2420/403; B60W 2420/408

(57) ABSTRACT

Disclosed herein a failover method based on redundant service and vehicle. The method includes: monitoring, by a second host, occurrence of a failure state during processing of a primary task while the primary task is executed on the first host; executing, by the second host or a third host, a preliminary task based on the failure state; and executing, by the second host, a subsequent task based on an output of the preliminary task.

### CROSS-REFERENCE TO RELATED APPLICATION

This application claims the benefit of priority to Korean Patent Application No. 10-2024-0185978, filed in the Korean Intellectual Property Office on Dec. 13, 2024, the disclosure of which is incorporated herein by reference in its entirety.

### TECHNICAL FIELD

The present disclosure relates to a failover method based on a redundant service and a vehicle, and more specifically, to a failover method based on a redundant service, which ensures robust operation reliability against a failure without changing a control structure of a controller and a network between the controller and electronic devices of a vehicle, and the vehicle.

### BACKGROUND

The matters described in this Background section are only for enhancement of understanding of the background of the disclosure, and should not be taken as acknowledgment that they correspond to prior art already known to those skilled in the art.

Vehicles including various functions for driving convenience have been commercialized. To this end, various functions such as an autonomous driving function, a manual driving support function, infotainment, etc., may be supported in vehicles.

The driving support function may be a system important to safety. When a processor for processing this function is provided alone, the reliability of hardware may be degraded. Accordingly, a controller for processing driving support may be formed by combining a plurality of processors with various performances. Communication between the plurality of processors may use high-speed Ethernet.

When a failure occurs in some processors or a communication failure occurs between the processors in the controller, a service or task related to the failure, which is performed by the processor, is not reliable. To prepare for such a situation, the same processor for performing the same task may be disposed as a plurality of processors. This may be a failover method through hardware redundancy but may cause increased complexity in the controller and the network between the controller and other devices of the vehicle.

As another method of preparing for failure situations, there may be hardware lockstep or software lockstep. A lockstep method may perform the same task in the same hardware to compare output results. The lockstep method may excessively increase the resource burden by executing a plurality of logics that process the same task simultaneously.

### SUMMARY

The present disclosure is directed to providing a failover method based on a redundant service, which ensures robust operation reliability against a failure without changing a control structure of a controller and a network between the controller and electronic devices of a vehicle, and the vehicle.

Objects of the present disclosure are not limited to the above-described object, and other objects that are not described will be able to be clearly understood by those skilled in the art to which the present disclosure pertains based on the following description.

According to the present disclosure, a method performed by an apparatus of a vehicle may comprise executing, by a first processor circuit of the vehicle, a primary task for operations of the vehicle; determining, by a second processor circuit of the vehicle, whether a failure state has occurred during the executing of the primary task; based on a determination that the failure state has occurred and by the second processor circuit or by a third processor circuit of the vehicle, executing a preliminary task that is of a same type as the primary task, wherein the preliminary task is executed with less resources of the vehicle than the primary task; and based on the determination that the failure state has occurred and an output of the preliminary task, executing, by the second processor circuit, a subsequent task.

The method of the present disclosure may further include that the failure state during the executing of the primary task is determined based on an operational state of the first processor circuit, and a communication state between the first processor circuit and the second processor circuit. The method of the present disclosure may further include that the executing of the primary task may comprise, before the executing of the preliminary task, determining whether both the primary task and the preliminary task are searched for in memory of the vehicle; assigning the primary task to the first processor circuit and assigning the preliminary task to the second processor circuit or the third processor circuit based on both the primary task and the preliminary task being searched for in the memory; and executing the primary task.

The method of the present disclosure may further include that the determining of whether both the primary task and the preliminary task are searched for is performed within a predetermined time window after booting of controller circuitry of the vehicle, wherein the controller circuitry may comprise the first processor circuit, the second processor circuit, and the third processor circuit.

The method of the present disclosure may further comprise, before the executing of the primary task, determining, by the second processor circuit, whether the failure state occurs as an initial condition for executing the primary task; based on the initial condition indicating that the failure state has occurred and by the second processor circuit or the third processor circuit, initiating execution of the preliminary task; and based on the initial condition indicating that no failure state has occurred and by the first processor circuit, initiating execution of the primary task.

According to the present disclosure, a vehicle may comprise controller circuitry including a first processor circuit, a second processor circuit, and a third processor circuit; and a memory storing at least one instruction that, when executed by the controller circuitry communicating with the memory, is configured to cause the vehicle to execute, by the first processor circuit, a primary task for operations of the vehicle; determine, by the second processor circuit, whether a failure state has occurred during the execution of the primary task; based on a determination that the failure state has occurred and by the second processor circuit or the third processor circuit, control a preliminary task to be executed, wherein the preliminary task is of a same type as the primary task, and wherein the preliminary task is executed with less resources of the vehicle than the primary task; and control a subsequent task, to be executed by the second processor circuit, based on an output of the preliminary task.

The vehicle of the present disclosure may further include that the controller circuitry is configured to, based on a determination that no failure state has occurred during the execution of the primary task, maintain, by the first processor circuit, the execution of the primary task; and based on an output of the primary task and by the second processor circuit, control execution of a subsequent task.

The vehicle of the present disclosure may further include that the first processor circuit has greater processing capability than the second processor circuit. The vehicle of the present disclosure may further include that the third processor circuit has greater processing capability than the second processor circuit.

The vehicle of the present disclosure may further include that the primary task and the preliminary task are driven by homogeneous applications, and the primary task is processed by an application that requires more resources of the vehicle than the preliminary task. The vehicle of the present disclosure may further include that the primary task is executed based on more types of sensor inputs than the preliminary task.

According to the present disclosure, a vehicle may comprise a sensor configured to detect an environment of the vehicle; a driving control circuit configured to control autonomous driving of the vehicle; at least one processor including a first processor and a second processor; and a memory storing at least one instruction that, when executed by the at least one processor communicating with the memory, is configured to cause the vehicle to execute, by the first processor, a primary task based on a set of sensor inputs from the sensor; determine, by the second processor, whether a failure occurs during the execution of the primary task; based on a determination that the failure has occurred, execute, by the second processor, a preliminary task that is of a same type as the primary task, wherein the preliminary task is executed with a reduced set of sensor inputs than the primary task; execute, by the second processor, a subsequent task based on an output of the preliminary task; and control, via the driving control circuit and based on the execution of the subsequent task, autonomous driving of the vehicle.

The vehicle of the present disclosure may further include that the at least one instruction, when executed by the at least one processor communicating with the memory, is configured to cause the vehicle to, based on a determination that no failure has occurred during the execution of the primary task, execute a subsequent task based on an output of the primary task.

The vehicle of the present disclosure may further include that the at least one instruction, when executed by the at least one processor communicating with the memory, is configured to cause the vehicle to execute the primary task using image data, radar data, and lidar data from the sensor, and execute the preliminary task using a subset of the image data and radar data.

The vehicle of the present disclosure may further include that the at least one instruction, when executed by the at least one processor communicating with the memory, is configured to cause the vehicle to determine the failure based on at least one of an operational state of the first processor, or a communication state between the first processor and the second processor.

The features briefly summarized above for this disclosure are only examples of the detailed description of the disclosure which follow, and are not intended to limit the scope of the disclosure.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 is an exemplary view showing a vehicle that communicates with another device to transmit and receive data;

FIG. 2 is a view showing modules constituting a vehicle according to one example of the present disclosure;

FIG. 3 is a view showing one example of a controller;

FIG. 4 is a view showing another example of the controller;

FIG. 5 is a view showing modules constituting a server according to the present disclosure;

FIG. 6 is a flowchart showing a failover method based on a redundant service according to another example of the present disclosure; and

FIG. 7 is an exemplary view showing a failover process based on a redundant service.

FIG. 8 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various different ways, and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of failover using redundant processors to maintain control during processor failure) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of failover using redundant processors to maintain control during processor failure) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of failover using redundant processors to maintain control during processor failure) described herein.

Minimum risk maneuver (MRM) operation(s) may also be controlled, for example, based on one or more features (e.g., feature of failover using redundant processors to maintain control during processor failure) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of failover using redundant processors to maintain control during processor failure) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of failover using redundant processors to maintain control during processor failure) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of failover using redundant processors to maintain control during processor failure) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle. Hereinafter, examples of the present disclosure will be described with reference to the accompanying drawings.

According to the present disclosure, a vehicle may maintain operational reliability by implementing a failover method based on a redundant service. A primary processor executes a primary task, such as processing sensor data for perception in autonomous driving, while one or more secondary processors may monitor whether a failure occurs during execution of the primary task. In the event of a failure state in the primary processor, the one or more secondary processors may execute a preliminary task that requires less computational resources than the primary task, for example, by processing a reduced set of sensor input data. The one or more secondary processors may execute a subsequent task based on the output of either the primary task or the preliminary task. Through this configuration, robust failover may be achieved without changing the control structure of the controller circuitry or the network between the controller circuitry and electronic devices of the vehicle, thereby ensuring continuous and reliable operation (e.g., autonomous driving of the vehicle) in failure situations.

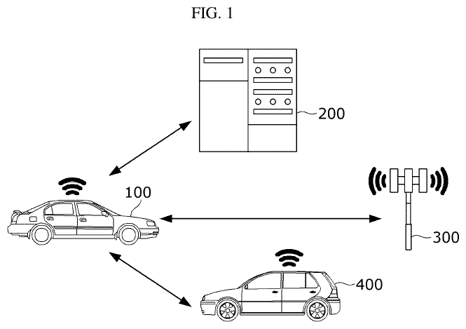

Hereinafter, a vehicle including a controller (or a vehicle controller) including a multi-host and a server will be described with reference to FIGS. 1 to 5.

FIG. 1 is an exemplary view showing a vehicle that communicates with another device to transmit and receive data.

Referring to FIG. 1, a vehicle 100 may be driven based on electrical energy or fossil energy. In the case of electrical energy, the vehicle 100 may be, for example, a pure battery-based vehicle driven by only a high-voltage battery or may adopt a gas-based fuel cell as an energy source. In addition, a fuel cell may use various types of gases that may generate electrical energy, and the gas may be charged into the vehicle 100, for example, in a liquefied state. Here, the gas may be, for example, hydrogen. However, the present disclosure is not limited thereto, and various gases may be applied (e.g., methane, ammonia, natural gas, or biogas, etc.). In the case of fossil energy, the vehicle 100 may be driven based on fuel such as gasoline, diesel, liquefied gas, etc. and provided with an internal combustion engine that drives an actuating unit 116 by combustion of the fuel. The engine may be included in a power source unit 114 in terms of providing a driving rotational force of a wheel to a wheel driver (not shown) of the actuating unit 116. As another example, the vehicle 100 may drive the actuating unit 116 selectively using an internal combustion engine based on fossil energy and the energy of an electric battery, which may be a hybrid-type vehicle (e.g., parallel hybrid, series hybrid, plug-in hybrid, or mild hybrid, etc.).

The vehicle 100 may be a movable device. The vehicle 100 is a ground vehicle that travels on the ground and may be a typical passenger or commercial vehicle, a purpose built vehicle (PBV), etc. (e.g., taxi, delivery van, or ride-sharing shuttle, etc.). The vehicle 100 may be a four-wheeled vehicle, for example, a passenger car, an SUV, or a small truck, or a vehicle with more than four wheels, for example, a bus, a large truck, a container transport vehicle, a heavy equipment vehicle, dump truck, fire truck, crane, or excavator, etc. The vehicle 100 may be a robot in a broad sense, such as a means of transportation, and the robot may move using wheels, tracks, or other moving modules.

The vehicle 100 may be manually driven by a user or controlled by autonomous driving. The autonomous driving may be implemented as semi-autonomous driving or full autonomous driving. The full autonomous driving may be provided as autonomous movement in which a controller 120 of the vehicle 100 has full control authority without user intervention (e.g., lane keeping, automatic overtaking, highway merging, or parking without assistance, etc.) even if a traveling situation is uncertain. The semi-autonomous driving may be provided as autonomous movement that requires driver intervention depending on a specific traveling situation (e.g., construction zones, poor weather, unusual traffic signals, or emergency vehicle approach, etc.). According to the level of the autonomous driving defined by the Society of Automotive Engineers (SAE), the semi-autonomous driving corresponds to autonomous driving levels 1 to 4, and the full autonomous driving corresponds to level 5.

The vehicle 100 may communicate with other devices 200 and 300 or another vehicle 400. The other devices may include, for example, a server 200 for supporting various controls, state management, and traveling of the vehicle 100, an intelligent transportation system (ITS) device 300 for receiving information from an ITS, or various types of user devices (e.g., smartphones, wearable devices, or tablets, etc.). The server 200 may be, for example, an external device operated by a vehicle manufacturer or provided to service autonomous driving and may receive connected data of the vehicle 100 or transmit data required for manual and autonomous driving. To support autonomous driving and various services of the vehicle 100, the server 200 may transmit various types of information and software modules (e.g., navigation updates, hazard alerts, AI-based driving strategies, or infotainment services, etc.) that are used for controlling the vehicle 100 to the vehicle 100 in response to the request and data transmitted from the vehicle 100 and the user device.

The ITS device 300 is, for example, a road side unit (RSU) and may exchange vehicle perception data, traveling control and state data, surrounding environmental data of a vehicle, map data, etc. with the vehicle 100 through vehicle-to-infrastructure (V2I) communication to assist a user driving his or her vehicle or support the autonomous driving of the vehicle 100 (e.g., signal phase and timing data, toll information, road hazard broadcasts, or congestion updates, etc.). The vehicle 100 may exchange the data listed above with another vehicle 400 through vehicle-to-vehicle (V2V) communication to support manual driving or autonomous driving (e.g., cooperative adaptive cruise control, collision warning, or platooning, etc.).

The vehicle 100 may communicate with another vehicle or other devices based on cellular communication, wireless access in vehicular environment (WAVE) communication, dedicated short range communication (DSRC), short-range communication, Bluetooth, Wi-Fi Direct, satellite communication, or other communication methods.

For example, the vehicle 100 may use a communication network such as Long Term Evolution (LTE) or 5G, a Wi-Fi communication network, a WAVE communication network, etc. as a cellular communication network to communicate with the server 200, the ITS device 300, and another vehicle 400 (e.g., cloud-based traffic servers, road-side units, or fleet management centers, etc.). As another example, DSRC or the like used in the vehicle 100 may be used for communication between vehicles (e.g., cooperative adaptive cruise control, collision avoidance signaling, or platooning, etc.). A communication method between the vehicle 100, the server 200, the ITS device 300, another vehicle 400, and the user device is not limited to the above example.

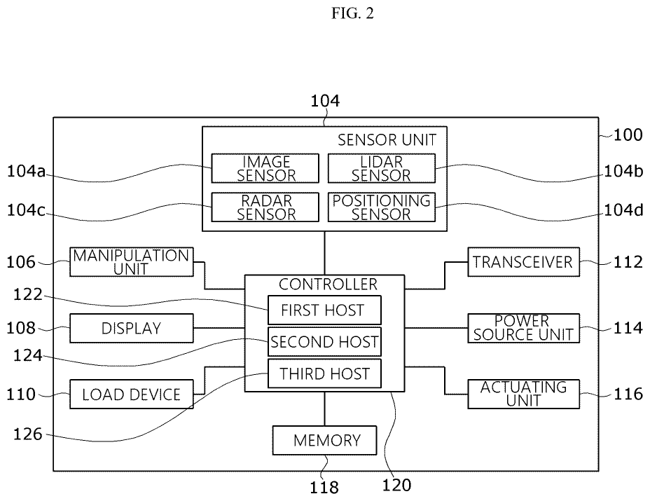

FIG. 2 shows an exemplary modules constituting a vehicle.

The vehicle 100 may include a sensor unit 104, a manipulation unit 106, a display 108, a load device 110, and a transceiver 112.

The sensor unit 104 may include various types of sensors for detecting various states and situations that occur in an external surrounding environment, internal system, user manipulation, and boarding space of the vehicle 100 (e.g., monitoring tire pressure, detecting rain on the windshield, identifying pedestrian movements, or sensing driver fatigue, etc.).

Specifically, the sensor unit 104 may include an outward facing image sensor 104a, a lidar sensor 104b, a radar sensor 104c, etc. to recognize dynamic and static objects which are present around the vehicle 100.

The image sensor 104a may recognize an external object as an image while the vehicle 100 is being used to generate image data and transmit the image data to the controller 120. The image sensor 104a may be installed on a plurality of portions of the vehicle 100 so that a plurality of images or multi-views of the surrounding environment of the vehicle 100 may be acquired (e.g., front-view, rear-view, surround-view, or bird's-eye view, etc.). The lidar sensor 104b may generate point cloud data on objects around the vehicle 100 and transmit the point cloud data to the controller 120. The point cloud data may include three-dimensional information of the object. The present disclosure provides an example in which the lidar sensor 104b is mounted, but in another example, the lidar sensor 104b may be omitted (e.g., when cost or weight reduction is prioritized, or when radar-only solutions are sufficient, etc.). The radar sensor 104c may emit radio waves of a specific frequency to a peripheral area of the vehicle 100 to generate radar data through radio waves reflected from an external object in order to identify the presence, relative distance, speed, direction, etc., of the external object (e.g., detecting fast-approaching vehicles, measuring distance to nearby walls, or tracking the relative speed of a pedestrian, etc.).

In addition, the sensor unit 104 may include a positioning sensor 104d for identifying a position of the vehicle 100. The positioning sensor 104d may be, for example, a global positioning system (GPS) sensor or a global navigation satellite system (GNSS) sensor, but is not limited thereto (e.g., BeiDou, Galileo, or GLONASS systems may also be used, etc.). In addition, the sensor unit 104 may include an attitude sensor (not shown). The attitude sensor may detect, for example, a three-axis state of the vehicle 100, for example, yaw, pitch, and roll, and output various attitude states of the vehicle based on the above factors (e.g., tilting during cornering, body roll on uneven roads, or nose-diving during sudden braking, etc.). Examples of the attitude sensor may include an inertia measurement unit (IMU) sensor, a gyro sensor, etc.

The sensors of the sensor unit 104 referred to the description of the present disclosure are mainly described, but sensors for detecting various situations, which are not listed above, may be additionally included (e.g., rain sensors, ultrasonic sensors, driver eye-tracking sensors, cabin temperature sensors, or biometric sensors, etc.).

The manipulation unit 106 may be formed as a module manipulated by a user for driving. For example, the manipulation unit 106 may be a steering wheel for manual driving, an automatic or manual transmission, an accelerator pedal, a brake pedal, a gear transmission, a joystick-type control, or a haptic feedback controller, etc. The manipulation unit 106 may further include an interface for using, deactivating, and selecting a specific function of an autonomous driving mode requested by the user so that the user may use the autonomous driving function. To receive various requests related to autonomous driving, the manipulation unit 106 may be composed of, for example, a hard type interface provided at a predetermined location in the vehicle 100 or a soft type interface that may be touched on the display 108 (e.g., a button on the dashboard, a rotary dial, or a voice-activated virtual assistant, etc.).

The display 108 may serve as a user interface. The display 108 may be controlled by the controller 120 to display an operation state, control state, route/traffic information, and remaining energy information of the vehicle 100, content requested by a driver, etc. In addition, the display 108 may be formed as a touch screen capable of detecting the input of the driver to receive the request of the driver that instructs the controller 120 (e.g., route selection, media playback, climate control, or driver authentication input, etc.).

The load device 110 may be mounted on the vehicle 100 and may be a type of non-driving electric device other than a driving power system such as the wheel driver and the like. The load device 110 is an auxiliary device for receiving power from the power source unit 114 and may be, for example, an air conditioning system, a lighting system, a seat system, an infotainment system, or a heating/ventilation system, etc., and various devices installed on the vehicle 100.

The transceiver 112 may support mutual communication with the server 200, the ITS device 300, a nearby vehicle 400, etc. The transceiver 112 may include, for example, a module for processing cellular communication, WAVE communication, DSRC, Bluetooth, or Wi-Fi Direct, etc. In the present disclosure, the transceiver 112 may transmit data generated or stored during driving to the server 200 and receive data and a software module transmitted from the server 200. The transceiver 112 may support communication with an electronic device of a passenger in the vehicle 100 (e.g., a smartphone, tablet, smartwatch, or laptop, etc.). In the present disclosure, the vehicle 100 may transmit and receive data used in the method according to the present disclosure with an external device through the transceiver 112.

In addition, the vehicle 100 may include the power source unit 114 and the actuating unit 116.

The power source unit 114 may generate and supply power and electric power that are used in a driving power system such as the actuating unit 116 and a non-driving power system. The non-driving power system may include, for example, the sensor unit 104, the manipulation unit 106, the display 108, the load device 110, the transceiver 112, etc., but is not limited thereto, and may include various components for implementing sensing, interface, communication, and convenience functions other than components directly involved in driving operations (e.g., charging ports, wireless chargers, electronic control modules, or cabin air purification systems, etc.).

When the vehicle 100 is driven based on electrical energy, the power source unit 114 may be formed as, for example, an electric battery charged from the outside or formed as a combination of an electric battery and a fuel cell that charges the battery. In the case of a combination of the electric battery and the fuel cell, the power source unit 114 may include a tank that stores a material used to produce power for the fuel cell, for example, liquefied hydrogen (e.g., liquid hydrogen tanks, compressed hydrogen tanks, or methanol reformers, etc.). When the vehicle 100 is driven based on fossil energy, the power source unit 114 may be configured as an internal combustion engine. In addition, when the vehicle 100 is a hybrid type, the power source unit 114 may be provided as a combination of the internal combustion engine and the electric battery (e.g., plug-in hybrid, mild hybrid, or range extender configurations, etc.).

The actuating unit 116 may include at least one module that implements a driving operation and perform at least one driving operation of longitudinal control such as acceleration and deceleration and lateral control such as steering, and gear shifting according to a user request from the manipulation unit 106 or a request of the controller 120. Here, the gear shifting may be processed by a request of a manual driving user using a gear transmission or a request of the controller 120 in autonomous driving (e.g., during adaptive cruise control, automated lane changes, or parking assist, etc.).

The actuating unit 116 may have a wheel driver (not shown) and a mechanical component and an electronic module for implementing a driving operation in the wheel driver in order to perform a driving operation according to a command of the controller 120 by a manual manipulation of the user or autonomous driving (e.g., an inverter, an electric motor, or a regenerative braking unit, etc.). When the vehicle 100 is operated based on electrical energy, the vehicle 100 may include an assembly for transmitting the requested driving operation to a wheel driver. When the vehicle 100 is operated based on fossil energy, the actuating unit 116 may include a transmission and a gear module for transmitting the power of an internal combustion engine (e.g., an automatic transmission, dual-clutch transmission, or continuously variable transmission (CVT), etc.).

The wheel driver may include a plurality of wheels, a driving force generation module for generating a driving force to impart the driving force to wheels or transmitting the driving force, a brake module for decelerating the driving of the wheels, a steering module for achieving lateral control of the wheels, a suspension system, or a traction control system, etc. When the vehicle 100 is driven based on electrical energy, the driving force generation module may be provided as a motor assembly for generating a driving force based on the power output from the electric battery (e.g., an induction motor, a permanent magnet synchronous motor, or a switched reluctance motor, etc.). The brake module of the electric-based vehicle 100 may further have a regenerative brake function (e.g., energy recovery during deceleration, downhill braking, or stop-and-go traffic, etc.).

In addition, the vehicle 100 may include a memory 118 and the controller 120. The memory 118 may store applications and various types of data for controlling the vehicle 100 and load the applications or read or write the data at the request of the controller 120.

The applications may be executed by the controller 120 having at least one vehicle controller for performing a specific function embedded therein.

The memory 118 may store at least one application used in the vehicle controller having a plurality of hosts 122 to 128 (e.g., a plurality of processors). The application may be software related to a task that performs a service used to implement a specific function of the vehicle controller. In the present disclosure, the task and the service may have substantially the same meaning and may be described as a task for convenience.

The application includes various types of data for performing the task and may include, for example, code data and application data. The code data may include execution code data of the application (e.g., compiled binary code, firmware instructions, or script-based execution files). The application data is data used for executing the application and may be, for example, input/output data, log files, setting files, parameters used for execution,, sensor calibration files, or communication protocol data, etc.

In the present disclosure, the memory 118 may manage an application for failover based on a redundant service if a failure occurs during the processing of a task in a specific host. A specific description of the application for failover will be described below.

The controller 120 may perform the overall control of the vehicle 100. The controller 120 may be configured to execute the applications and instructions that are stored in the memory 118 (e.g., software modules for braking, lane keeping, collision avoidance, or battery management, etc.).

As shown in FIG. 2, the controller 120 includes at least one vehicle controller, and the vehicle controller may have a plurality of hosts 122, 124, and 126. In the present disclosure, the controller having the plurality of hosts 122, 124, and 126 may be referred to as a multi-host controller. In the present disclosure, for convenience of description, an example in which the controller is mounted on a vehicle will be mainly described. The present disclosure is not limited thereto, and when a controller used in electronic devices other than a vehicle, for example, a mobile terminal, a desktop computer, a laptop computer, a cloud server, a drone, or an industrial robot, etc., includes a plurality of hosts, such a controller may be referred to as a multi-host controller.

The controller 120 may include, for example, at least one of an electric control unit (ECU), a motor control unit (MCU), a transmission control unit (TCU), a battery management system (BMS), an air-conditioning controller, an electric drive control unit (EDCU), and a vehicle communication network controller, but is not limited thereto, and may be a vehicle controller with various functions (e.g., infotainment systems, adaptive cruise control units, or advanced driver-assistance controllers, etc.).

As the vehicle controller, for example, the ECU may process various functions, such as autonomous driving control, powertrain control, transmission control, brake control, regenerative braking control, lighting control, door lock control, safety device control, infotainment control, and suspension control. Among the various functions of the ECU, the autonomous driving control may include specific tasks, for example, perception processing, determination processing, and driving control processing. The perception processing may include recognizing objects around a vehicle based on sensor data detected from the sensor unit 104 (e.g., camera images, radar signals, ultrasonic data, or LiDAR point clouds, etc.). The perception processing may be based on machine learning that identifies objects by fusing a plurality of sensor data. The determination processing may include establishing a future driving operation plan based on the recognized object (e.g., planning lane changes, overtaking maneuvers, turning decisions, or braking distances, etc.). The driving control processing may include, for example, performing longitudinal control, lateral control, and control of the actuating unit 116 based on the driving operation plan (e.g., throttle actuation, steering angle control, brake pressure modulation, or motor torque control, etc.).

The powertrain controlled by the ECU may be, for example, one of an engine, an electric battery/motor, and a fuel cell/electric battery/motor (e.g., hybrid systems, plug-in hybrid systems, or hydrogen fuel cell-electric systems, etc.). The ECU may include a plurality of hosts to process specific tasks of the listed functions. Each host or a plurality of combined hosts may perform tasks.

The application may be a software program related to at least one task used to perform a function of the exemplary vehicle controller. The exemplary vehicle controller may process a plurality of tasks related to a specific function, and the vehicle controller may include the plurality of hosts 122, 124, and 126 used to process a plurality of tasks. Specifically, the hosts 122, 124, and 126 may include a processing unit and execute at least one task (e.g., sensor fusion, motion prediction, path planning, or energy management, etc.). In the present disclosure, for convenience of description, tasks and applications may be described interchangeably.

The hosts 122, 124, and 126 may be hardware units or software components. As an example of the hardware unit, the hosts 122, 124, and 126 may be a system on chip (SoC). The hosts 122, 124, and 126 may include components having various functions. For example, the hosts 122, 124, and 126 include a processor core, a memory block, a timing generator, an external interface, and a converter, and these components may be connected in a bus structure using various communication methods (e.g., may bus, Ethernet, PCIe, or wireless interconnects, etc.). The components of the hosts 122, 124, and 126 are exemplary, and the hosts 122, 124, and 126 may include other components (e.g., accelerators for AI inference, security modules, or dedicated image processors, etc.).

The processor core may include, for example, a central processing unit (CPU), a graphics processing unit (GPU), and a digital signal processor (DSP). The processor core may be formed as a multi-core. The processor core may further include additional components, for example, a neural processing unit (NPU), depending on the type of processing required by the task (e.g., image recognition, sensor fusion, speech processing, or path planning, etc.). The memory block is a storage of the hosts 122, 124, and 126 and may have, for example, a random access memory (RAM), a read only memory (ROM), and a flash memory (e.g., NAND flash, NOR flash, or eMMC storage, etc.). The timing generator may include, for example, a timing generator phase-locked loop (PPL) (e.g., for synchronizing clock signals in high-speed communication, video rendering, or motor control, etc.). The external interface may include, for example, at least one of Ethernet, peripheral component interconnect express (PCIe), and a universal serial bus (USB). The converter may include, for example, an analog-to-digital converter and a digital-to-analog converter (e.g., audio codecs, image sensor converters, or battery monitoring converters, etc.).

The hosts 122, 124, and 126 may have different components and different specifications. For example, a first host 122 and a third host 126 may have higher resource performance than a second host 124 (e.g., faster processors, larger memory, or higher data throughput, etc.). The first host 122 and the third host 126, for example, related to higher resource performance may include components that perform tasks that the second host 124 cannot handle without being embedded in the second host 124. As another example, at least one of the plurality of components of the first host 122 and the third host 126 may have higher specifications than the second host 124 (e.g., higher GPU cores, wider memory bandwidth, or faster communication protocols, etc.). As still another example, a combination of the plurality of components of the first host 122 and the third host 126 may have higher processing capability than the second host 124.

As a more specific example, the first host 122 and the third host 126 may be application processors (APs), and the second host 124 may be a micro-controller (MCU). The AP may be a host for processing tasks by at least one of a larger amount of input data, a larger amount of calculations, and a larger number of parameters than the MCU (e.g., image classification, real-time mapping, or neural inference, etc.). In addition, the AP may have higher resource performance than the MCU by including components that are not embedded in the MCU to execute tasks different from those of the MCU. For example, the AP may include an NPU in addition to the CPU and GPU to perform machine learning-based perception processing required for autonomous driving control of the ECU (e.g., pedestrian detection, lane recognition, or obstacle classification, etc.). As another example, the AP may have an NPU with better performance than the MCU (e.g., higher TOPS rate, parallel matrix multipliers, or AI accelerators, etc.). On the other hand, the MCU may have higher system stability than the AP (e.g., predictable real-time response, safety-critical operation handling, or reduced failure rates, etc.).

As a more specific example, the second host 124 may have a CPU, a GPU, a low-performance NPU, a low-capacity RAM or ROM, and a low-speed communication method. The first host 122 and the third host 126 may have higher performance and higher capacity than the second host 124 in at least some components, for example, a GPU, an NPU, a RAM, and a communication method (e.g., PCIe Gen4, high-bandwidth memory (HBM), or automotive Ethernet, etc.). Even when the first host 122 and the third host 126 are provided as APs, they may have different or identical components and performances depending on design specifications.

The AP and the MCU may share and process a plurality of tasks for performing specific functions in the vehicle controller. The processing unit included in the AP may process a task requiring high resource performance and transmit an output (or output data) according to the processing to the MCU (e.g., object detection results, motion predictions, or trajectory plans, etc.). The processing unit of the MCU may execute a task requiring low resource performance while using the output data of the AP and transmit an output (or output data) according to the execution to a target member or component outside the controller 120, for example, the actuating unit 116, the display 108, the load device 110, a warning alarm, or a navigation module, etc. The output data of the MCU may be transmitted to the target component using a vehicle network (e.g., may bus, LIN, FlexRay, or automotive Ethernet, etc.).

In the present disclosure, the processing units of the first host 122 and the third host 126 corresponding to the AP may be service provider devices in terms of providing output data to tasks of other processing units. The processing unit of the second host 124 corresponding to the MCU may be a service consumer device in terms of receiving output data of the service provider device and processing tasks.

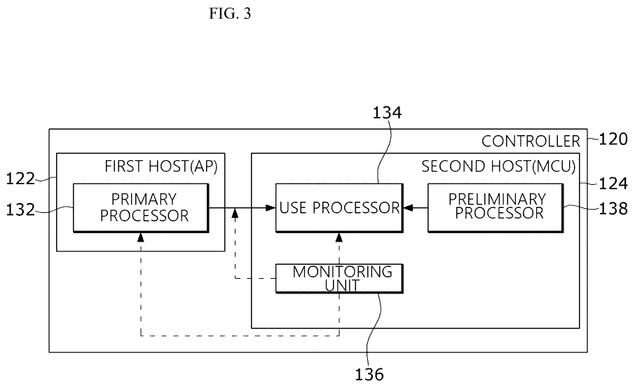

The service provider device and the service consumer device are not limited to hosts exchanging data and may also be applied to a plurality of processing units that process a plurality of tasks in the single host 124. For example, as shown in FIG. 3, the single host 124 may have a plurality of processing units 134 and 138, the processing unit 138 may transmit output data according to the execution of a task to the other processing unit 134, and the other processing unit 134 may transmit output data according to the processing of a task to a targeted component (e.g., steering actuator, braking system, or display unit, etc.). FIG. 3 is a view showing one example of a controller. In this example, the processing unit 138 may correspond to the service provider device, and the processing unit 134 may correspond to the service consumer device.

In the present disclosure, an example that the vehicle controller with various functions is mounted on the single controller 120 is described, but an ECU, an MCU, a TCU, a BMS, an air conditioning controller, an EDCU, a vehicle communication network controller, etc. may each be distributed and installed (e.g., in different domains such as powertrain, chassis, or infotainment systems, etc.). In the present disclosure, for convenience of description, an example in which a plurality of vehicle controllers are embedded in a virtual single controller 120 is described, but the present disclosure may also be applied to an example in which each vehicle controller is implemented as an individual processor in substantially the same manner.

As shown in FIG. 3, the controller 120 serving as a vehicle controller may include the first host 122 and the second host 124. As described above, the first host 122 may have higher resource performance than the second host 124. For example, the first host 122 may be an AP and the second host 124 may be an MCU.

The first host 122 may include a primary processor 132 capable of processing a primary task by the controller 120. The primary processor 132 may execute some tasks among specific functions assigned to the controller 120 and transmit output data of the executed tasks to the second host 124 (e.g., processed image features, fused sensor results, or predictive control signals, etc.). The primary processor 132 may process a task that precedes the second host 124 among a series of tasks for implementing specific functions. The primary task may include a single subtask or a plurality of subtasks, and the primary processor 132 may load at least one application to execute the primary task (e.g., object recognition, map updating, or energy optimization, etc.). The first host 122 may include at least one other processor in addition to the primary processor 132, and resource performances of the other processors and the primary processor 132 may be the same or different.

The second host 124 may process a subsequent task by the controller 120, monitor a failure state during the processing of the primary task, and execute a preliminary task based on the failure state. The second host 124 may include a use processor 134, a monitoring unit 136, and a preliminary processor 138. The use processor 134 may process the subsequent task based on output data of the primary task. Among specific functions of the subsequent task, the subsequent task may be a task subsequent to the task of the first host 122. The subsequent task may be processed with lower resource performance than the primary task. The subsequent task may include a single subtask or a plurality of subtasks, and the use processor 134 may load at least one application to execute the subsequent task (e.g., decision-making, motion planning, or actuator control, etc.). For example, when the primary task is perception processing during autonomous driving control performed by the ECU, the subsequent task may be a task subsequent to the perception processing and may be determination processing or a processing that includes both the determination processing and the driving control processing (e.g., lane-change decision, braking initiation, or steering adjustment, etc.).

The monitoring unit 136 may monitor whether a failure state is caused during the processing of the primary task on the first host 122 before or during the execution of the primary task on the first host 122 and determine a normal state or a failure state. The state monitored in relation to the processing of the primary task may be, for example, a device state of the first host 122 and a communication state between the first host 122 and the second host 124 (e.g., CPU temperature, memory usage, bus latency, or packet error rate, etc.). The monitoring unit 136 may determine the failure state during the processing based on the device state and the communication state.

The device state of the first host 122 may be, for example, an operation state of a component related to the first host 122 used for executing the primary task. The failure state due to the device state may be, for example, an error of a power supply, an error due to a high temperature of a component constituting a processor core, or an operation error of a memory block (e.g., voltage drop, thermal throttling, or RAM corruption, etc.), but is not limited thereto. The operation error of the memory block may be, for example, a lack of available memory, a sudden decrease in an execution speed of a memory, a sudden decrease in a transmission bandwidth, or a delay time exceeding a predetermined value (e.g., insufficient RAM for sensor fusion, limited cache availability, or delayed access to flash storage, etc.).

The failure state related to the communication state between the first host 122 and the second host 124 may be, for example, a failure of a transmission line between hosts, a delay in transmission time between the hosts, a data error transmission due to a loss or destruction of output data of a primary task, or a transmission of distorted output data (e.g., may bus disconnection, Ethernet jitter, packet loss, or corrupted frame data, etc.), but is not limited thereto.

In response to the processing in a normal state, the monitoring unit 136 may transmit a message to the first host 122 or the primary processor 132 to maintain the primary task being executed. The use processor 134 may execute a subsequent task using the output of the primary task that is normally output based on the normal state.

The monitoring unit 136 may transmit a message to the first host 122 or the primary processor 132 to deactivate the primary task being executed in response to the failure state and transmit a message to the preliminary processor 138 to activate the preliminary task to be executed based on the failure state (e.g., switching to a lightweight perception model, reducing sensor input usage, or initiating emergency braking control, etc.).

In addition, the preliminary processor 138 may execute a preliminary task that is the same as the primary task based on the message related to the failure state during the processing of the primary task. The preliminary processor 138 may load an application that is the same as the application of the primary task and execute the preliminary task. Since the second host 124 has lower resource performance than the first host 122, the preliminary processor 138 limited to the resources of the second host 124 may have lower resource performance than the primary processor 132. Accordingly, the application related to the preliminary task may be executed while requiring less resources than the application of the primary task (e.g., reduced frame resolution, down sampled sensor inputs, or simplified control models, etc.).

For example, since the primary task may be executed based on more types of input than the preliminary task, the preliminary task may be executed by an application that uses fewer resources than the application of the primary task (e.g., relying only on camera input without radar/LiDAR fusion, or using a lightweight neural network instead of a deep CNN, etc.). The application of the preliminary task driven by fewer resources is not limited to the form of the above example and may be constructed in various ways.

For example, when the primary task is perception processing during autonomous driving control, the preliminary task may be perception processing (e.g., simplified object recognition, limited lane detection, or reduced obstacle classification, etc.). The primary task may output object recognition information using the image data of the image sensor 104a, the point cloud data of the lidar sensor 104b, and the radar data of the radar sensor 104c as input data. In this case, the preliminary task has fewer types or less data than the primary task. For example, the input data of the preliminary task may be image data and radar data rather than point cloud data (e.g., using only camera frames and Doppler radar readings while omitting high-density 3D lidar data, etc.).

The second host 124 may include at least one other processor in addition to the above module, and resource performances of the other processors and the use processor 134 or the preliminary processor 138 may be the same or different (e.g., equal clock speed but different memory bandwidth, or different instruction sets, etc.).

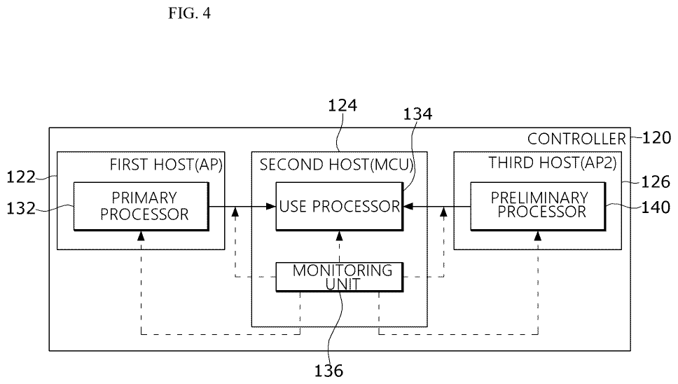

The controller 120 serving as the vehicle controller may include a configuration shown differently from FIG. 3. FIG. 4 is a view showing another example of the controller. FIG. 4 is substantially the same as the configuration of FIG. 3, except that the preliminary processor 140 is disposed in the third host 126. The configurations and functions related to the controller 120 of FIG. 4, which are different from those of FIG. 3 will be mainly described.

The controller 120 may include the first host 122, the second host 124, and the third host 126. The first host 122 may include the primary processor 132 capable of executing the primary task (e.g., perception processing, trajectory planning, or braking control, etc.). The second host 124 may include the use processor 134 capable of executing the subsequent task (e.g., determination processing, actuator command scheduling, or infotainment-related processing, etc.) and the monitoring unit 136 for detecting the failure state during the processing of the primary task (e.g., detecting power supply errors, overheating, or communication timeouts, etc.). Since specific configurations and functions related to the first and second hosts 122 and 124 are substantially the same as those of FIG. 3, the descriptions thereof will be omitted.

The third host 126 may include the preliminary processor 140 for executing the preliminary task that is the same as the primary task in response to the failure state during the processing of the primary task (e.g., rerunning object detection, performing simplified perception, or initiating backup braking logic, etc.). The third host 126 may have higher resource performance than the second host 124 and have resource performance capable of executing the preliminary task. The third host 126 may be an AP similar to the first host 122. The resource performances of the third host 126 and the first host 122 may be the same or different (e.g., same processing speed but different cache size, or same RAM but different GPU capability, etc.).

The preliminary processor 140 may load an application that is the same as the application of the primary task and execute the preliminary task. The third host 126 may load an application driven by the same resources as the primary task (e.g., full-resolution image recognition, LiDAR-based mapping, or high-frequency radar fusion, etc.) or an application driven by fewer resources than the primary task (e.g., low-resolution image analysis, radar-only detection, or simplified trajectory estimation, etc.) and execute the preliminary task. In the case of applications of the same resources, the preliminary task may generate output data using the same type or amount of input data as the primary task (e.g., using both image, radar, and LiDAR data simultaneously, etc.). Since the third host 126 may have another processor that executes another application (or another task) in addition to the preliminary processor 140, the preliminary processor 140 may execute the preliminary task with fewer resources than the primary task in order to distribute resources and alleviate the burden between another task of the third host 126 and the preliminary task (e.g., sharing CPU cycles, limiting GPU usage, or prioritizing real-time control processes, etc.).

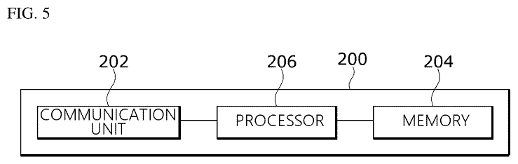

FIG. 5 is a view showing modules constituting a server according to the present disclosure.

The server 200 may transmit response data according to the request of the vehicle 100 to the vehicle 100 and also transmit information for supporting an application embedded in the vehicle 100 and vehicle driving to the vehicle 100 (e.g., over-the-air software updates, real-time navigation data, or remote diagnostic information, etc.). The server 200 may include a communication unit 202, a memory 204, and a processor 206.

The communication unit 202 may transmit and receive data with an external device, support mutual communication with the vehicle 100 in the present disclosure, and exchange data with the vehicle 100 (e.g., via 5G, Wi-Fi, or satellite link, etc.).

The memory 204 may store a program and various types of data for operating the server 200 and load the program or read and record the data at the request of the processor 206. The memory 204 may store and manage a program for processing a request of the vehicle 100, an application embedded in the vehicle 100, and information for supporting driving (e.g., HD maps, AI model updates, or predictive maintenance logs, etc.).

The processor 206 may perform the overall control of the server 200. The server 200 may be configured to execute the program and instructions that are stored in the memory 204. The processor 206 may execute the program to process and respond to a user request transmitted from the vehicle 100 (e.g., sending route recalculations, updating infotainment content, or transmitting charging station availability, etc.).

In the present disclosure, the processor 206 is, for example, formed as a single processing module. As another example, the processor 206 may be composed of a plurality of processing modules so that the above processing may be performed by the processing modules (e.g., separating AI inference from database management, or isolating security monitoring from communication handling, etc.).

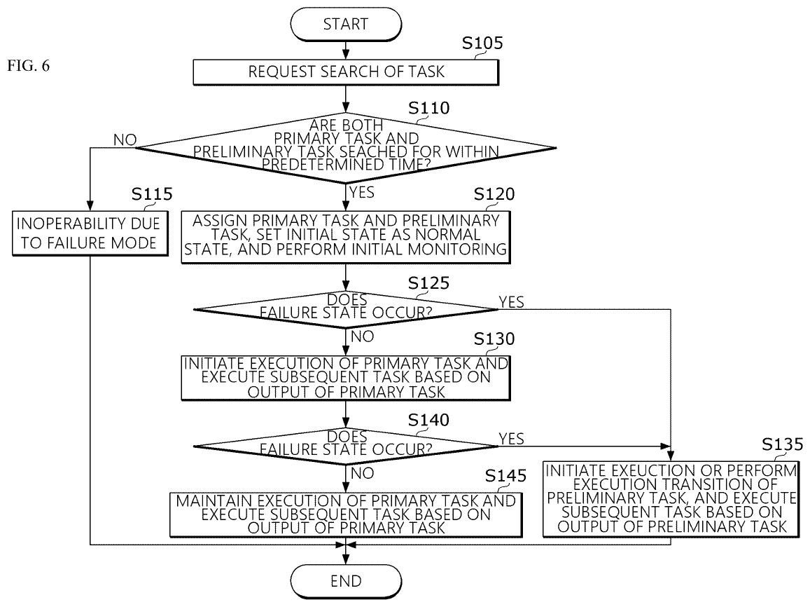

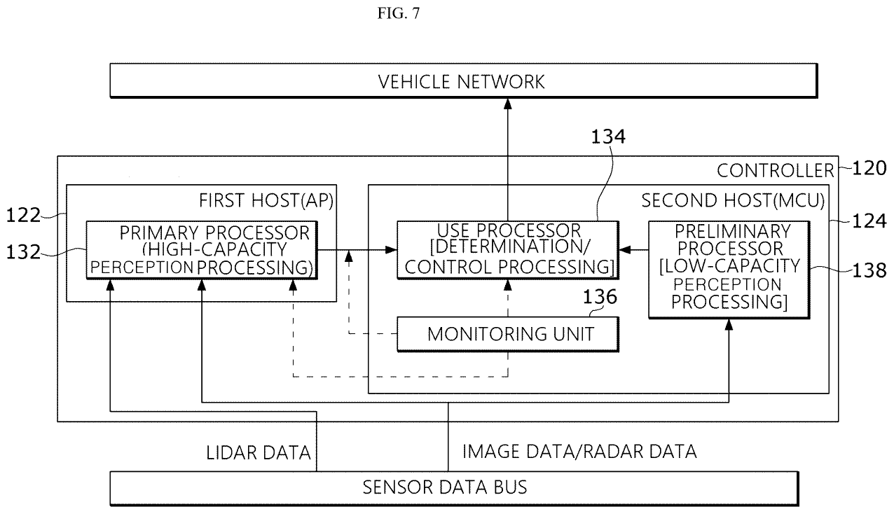

Hereinafter, a failover method based on a redundant service according to another example of the present disclosure will be described in detail with reference to FIGS. 6 and 7. FIG. 6 is a flowchart showing a failover method based on a redundant service according to another example of the present disclosure. FIG. 7 is an exemplary view showing a failover process based on a redundant service.

Hereinafter, an example in which the controller 120 has the configuration of FIG. 3 may be described. In addition, the controller 120 is an ECU for processing an autonomous driving function and, for example, processes tasks of the autonomous driving function (e.g., lane-keeping, adaptive cruise control, collision avoidance, or parking assistance, etc.). The first host 122 may be an AP, and the second host 124 may be an MCU. In addition, for example, the primary task may be perception processing, and the subsequent task may include determination processing and control processing (e.g., path planning, steering/braking control, or throttle adjustment, etc.). In addition, for example, the primary task and the preliminary task may be driven by the same type of application, and the primary task may be processed by an application that requires more resources than the preliminary task. The following description of FIG. 6 will be made as an example of the above description, but may be applied to various functions, various tasks, and the controller 120 of FIG. 4 of the vehicle controller in substantially the same manner.

Referring to FIG. 6, the controller 120 may request the search of at least one task for processing the above function based on the request for the specific function (S105).

The controller 120 may request the memory 118 to identify a primary task, a subsequent task, and a preliminary task related to the above function and may check operation states of the first and second hosts 122 and 124.

According to the example of FIG. 7, the primary task may be a perception application corresponding to perception processing. The subsequent task may include a determination application and a driving control application corresponding to determination processing and driving control processing, respectively. The preliminary task is perception processing that is the same type as the primary task, and more specifically, may search for a perception application that is the same type as the perception application of the primary task. The perception application of the preliminary task may be driven with fewer resources than the application of the primary task (e.g., low-resolution image analysis instead of high-resolution, radar-only fusion instead of radar+LiDAR fusion, or reduced sensor sampling rate, etc.).

The operational states of the hosts 122 and 124 may include their resource states and availabilities of the primary processor 132, the use processor 134, and the preliminary processor 138. For example, the operation state may include applications being executed on the hosts 122 and 124, resource states of the processors constituting the hosts 122 and 124, and resource states related to the primary processor 132, the use processor 134, and the preliminary processor 138 that may be allocated to the hosts 122 and 124.

The controller 120 may determine whether at least all of the primary tasks and the preliminary task are searched for within a predetermined time (S110).

The predetermined time may be, for example, a range from the booting of the controller 120 to a predetermined time. The booting of the controller 120 may include a specific operation of the controller 120 due to a request for a new function, for example, turning on the controller, activating an idle controller or processor, resuming a sleeping controller or processor, or resuming a reset controller or processor (e.g., after a firmware update, system crash, or cold start, etc.). The predetermined time may be the time normally allowed or required to access the memory 118 and search for all the main and preliminary tasks if the controller 120 and the memory 118 are in a normal state.

In addition, the controller 120 may determine whether a subsequent task is searched for and whether each of the searched for tasks may be assigned to the primary processor 132, the use processor 134, and the preliminary processor 138 based on the operation states of the first and second hosts 122 and 124.

In operation S110, if a task is not searched for or not assigned, the controller 120 may determine that the requested function is in a failure mode and may not perform the corresponding function (S115).

In operation S110, if each task is searched for and assigned, the controller 120 may control the first host 122 and the second host 124 to assign the primary task and the preliminary task to the primary processor 132 and the preliminary processor 138, respectively. In addition, the monitoring unit 136 of the second host 124 may temporarily set an initial state related to the processing of the primary task as a normal state by the controller 120 and monitor an actual initial state related to the above processing (S120).

The monitoring of the actual initial state may include, for example, detecting whether a failure state that is the same as the failure state during the processing of the primary task being executed occurs (e.g., memory overload, communication timeout, or sensor malfunction, etc.). Specifically, the failure state may be determined based on the device state of the first host and the communication state between the first host and the second host, and each state may be substantially the same as the above example.

If the failure state does not occur in the actual initial state for processing the primary task during the initial monitoring, the primary processor 132 of the first host 122 may initiate the execution of the primary task (e.g., perception processing, path planning, sensor fusion, or environment mapping, etc.), and the use processor 134 of the second host 124 may execute the subsequent task (e.g., determination processing, driving control, collision avoidance, or lane-change decision, etc.) based on the output of the primary task (S130).

According to the example of FIG. 7, the primary processor 132 may receive a message indicating that the initial state is a normal state from the monitoring unit 136. The primary processor 132 may execute a perception application related to the primary task (e.g., object detection, lane marking recognition, pedestrian tracking, or traffic sign identification, etc.) based on the initial normal state and output object recognition information according to the perception processing. The perception application may use machine learning (e.g., convolutional neural networks, recurrent neural networks, or transformer-based vision models, etc.) for perception processing. The perception application may execute perception processing using a larger amount of input data than the perception application of the preliminary processor 138. The perception application may output object recognition information based on a larger amount of input data including, for example, image data, point cloud data, radar data, or ultrasonic data, etc. The perception application may fuse the image data, the point cloud data, and the radar data, and other sensor modalities (e.g., infrared or GPS data, etc.) and output the object recognition information at a view at a predetermined time point based on the fused sensor data.

The use processor 134 may execute the determination application and driving control application related to the subsequent task (e.g., path planning, collision risk assessment, or adaptive cruise control, etc.)based on the object recognition information of the primary processor 132 and generate driving control information according to determination processing and driving control processing. For example, the driving control information may be transmitted to the actuating unit 116 through a vehicle network so that the vehicle 100 may be autonomously controlled by the driving control information.

If a failure state occurs in the actual initial state for processing the primary task in operation S125, the preliminary processor 138 of the second host 124 may initiate the execution of the preliminary task (e.g., simplified perception, emergency fallback detection, or reduced-speed environment monitoring, etc.), and the use processor 134 of the second host 124 may execute the subsequent task based on the output of the preliminary task (S135).

According to the example of FIG. 7, the preliminary processor 138 may receive a message indicating that the initial state is a failure state from the monitoring unit 136. The preliminary processor 138 may execute a perception application related to the preliminary task (e.g., low-resolution image recognition, basic radar target detection, or object presence/absence classification, etc.) based on the initial failure state and output object recognition information according to the perception processing. The perception application may use machine learning (e.g., lightweight neural networks, decision trees, or heuristic classifiers, etc.) for perception processing. The perception application may execute perception processing using lower-capacity input data than the perception application of the primary processor 132. The perception application may output object recognition information based on low-capacity input data including, for example, image data and radar data (rather than point cloud data or multi-sensor fusion, etc.). The perception application may fuse image data and radar data (e.g., combining camera-based lane detection with radar-based distance estimation, etc.) and output object recognition information at a view at a predetermined time point based on the fused sensor data.

The use processor 134 may execute the determination application and driving control application related to the subsequent task (e.g., simplified steering correction, braking control, or speed reduction commands, etc.) based on the object recognition information of the preliminary processor 138 and generate driving control information according to determination processing and driving control processing. For example, the driving control information may be transmitted to the actuating unit 116 through a vehicle network so that the vehicle 100 may be autonomously controlled by the driving control information.

Referring to FIG. 6, the monitoring unit 136 of the second host 124 may monitor whether a failure state occurs during the processing of the primary task being executed (e.g., perception, localization, or object tracking, etc.) according to operation S130 by the controller 120 (S140).

As described above, the failure state may be determined based on the device state of the first host and the communication state between the first host and the second host (e.g., processor overheating, abnormal latency, or loss of communication signals, etc.), and each state may be substantially the same as the above example.

If the failure state does not occur during the processing of the primary task being executed, the primary processor 132 maintains the primary task being executed, and the use processor 134 may execute the subsequent task (e.g., path planning, braking control, or adaptive lane-keeping, etc.) based on the output of the primary task (S145).

According to the example of FIG. 7, the primary processor 132 may receive a message indicating that the initial state is a normal state during the processing being executed from the monitoring unit 136. The primary processor 132 may maintain the execution of the perception application related to the primary task (e.g., pedestrian detection, vehicle classification, or traffic sign recognition, etc.) based on the normal state and output object recognition information according to the perception processing. The perception application may use machine learning (e.g., convolutional neural networks, random forests, or ensemble classifiers, etc.) for perception processing. The perception application may execute perception processing using a larger amount of input data than the perception application of the preliminary processor 138. As described in operation S130, the perception application may output the object recognition information based on high-capacity input data including image data, point cloud data, radar data, or infrared data, etc.

The use processor 134 may generate driving control information by executing the determination application and driving control application (e.g., steering angle control, acceleration adjustment, or collision avoidance maneuvers, etc.) related to the subsequent task based on the object recognition information of the primary processor 132 that maintains execution. For example, the driving control information may be transmitted to the actuating unit 116 through a vehicle network (e.g., may bus, FlexRay, or Ethernet, etc.) so that the vehicle 100 may be autonomously controlled by the driving control information.

In operation S140, if the failure state occurs during the processing of the primary task being executed, the preliminary processor 138 may execute the preliminary task by the execution transition of the primary task, and the use processor 134 may execute the subsequent task based on the output of the preliminary task (S135).

According to the example of FIG. 7, the preliminary processor 138 may receive a message indicating that the initial state is a failure state from the monitoring unit 136. Based on the failure state, the preliminary processor 138 may stop the execution of the primary task in the primary processor 132 and execute a perception application related to the preliminary task (e.g., radar-only target tracking, monocular camera lane detection, or basic obstacle presence detection, etc.) to output object recognition information according to the perception processing. The perception application may use machine learning (e.g., lightweight decision trees, compressed neural networks, or support vector machines, etc.) for perception processing. The perception application may execute perception processing using lower-capacity input data than the perception application of the primary processor 132. The perception application may output object recognition information based on low-capacity input data including, for example, image data and radar data (rather than lidar point clouds or fused multi-sensor data, etc.).

The use processor 134 may generate driving control information by executing the determination application and driving control application (e.g., safe stop control, speed reduction, or lane-holding under reduced functionality, etc.) related to the subsequent task based on the object recognition information of the preliminary processor 138 according to execution transition. For example, the driving control information may be transmitted to the actuating unit 116 through a vehicle network so that the vehicle 100 may be autonomously controlled by the driving control information.

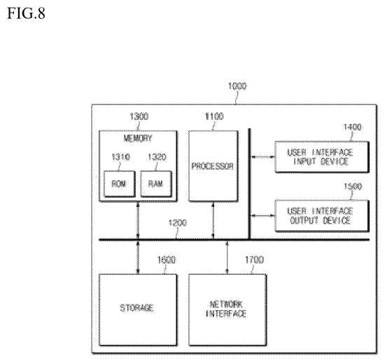

FIG. 8 shows an example computing system (e.g., a computing device of a vehicle or any other apparatus). One or more controllers, processors, etc. described herein, such as one or more components of the vehicle 100 and any other components and devices disclosed herein, may be implemented by or in the computing system as shown in FIG. 8. A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to the present disclosure, there is provided a gaze tracking method, the method comprising: monitoring, by a second host, occurrence of a failure state during processing of a primary task while the primary task is executed on the first host; executing, by the second host or a third host, a preliminary task based on the failure state; and executing, by the second host, a subsequent task based on an output of the preliminary task.

According to the example of the present disclosure in the method, the method may further comprise: maintaining, by the first host, the primary task being executed based on a normal state during the processing of the primary task; and controlling, by the second host, the executing of the subsequent task based on an output of the primary task.

According to the example of the present disclosure in the method, the first host may have higher resource performance than the second host.

According to the example of the present disclosure in the method, the third host may have higher resource performance than the second host.

According to the example of the present disclosure in the method, the primary task and the preliminary task may be driven by homogeneous applications, and the primary task may be processed by an application that requires more resources than the preliminary task.

According to the example of the present disclosure in the method, the primary task may be executed based on more types of input than the preliminary task.

According to the example of the present disclosure in the method, the failure state during the processing of the primary task may be determined based on a device state of the first host and a communication state between the first host and the second host.

According to the example of the present disclosure in the method, the method may further comprise: prior to the executing of the preliminary task, determining whether both the primary task and the preliminary task are searched for; assigning the primary task to the first host and assigning the preliminary task to the second host or the third host based on both the primary task and the preliminary task being searched for; and executing the primary task.

According to the example of the present disclosure in the method, the determining of whether both the primary task and the preliminary task may be searched for is performed within a range of a predetermined time after booting of a controller including the first host, the second host, and the third host.

According to the example of the present disclosure in the method, the method may further comprise: prior to the executing of the primary task, monitoring, by the second host, whether the failure state occurs to be an initial state for processing the primary task; initiating, by the second host or the third host, the preliminary task to be executed in response to the failure state; and initiating, by the first host, the primary task to be executed in response to a normal state during the processing of the primary task.

According to another example of the present disclosure, there is provided a vehicle that performs a failover based on a redundant service, the vehicle comprising: a memory that stores at least one instruction; and at least one controller that executes the at least one instruction stored in the memory and has a first host for processing a primary task, a second host for processing a subsequent task, and a third host for processing a task. The at least one controller is configured to: monitor, by the second host, occurrence of a failure state during processing of the primary task while the primary task is executed on the first host; control, by the second host or the third host, a preliminary task to be executed based on the failure state; and control the subsequent task to be executed based on an output of the preliminary task.

According to the present disclosure, it is possible to ensure robust operation reliability against a failure without changing a control structure of a controller and a network between the controller and electronic devices of a vehicle.

Effects obtainable from the present disclosure are not limited to the above-described effects, and other effects that are not described will be able to be clearly understood by those skilled in the art to which the present disclosure pertains based on the following description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus of a vehicle, the method comprising:
executing, by a first processor circuit of the vehicle, a primary task for operations of the vehicle;
determining, by a second processor circuit of the vehicle, whether a failure state has occurred during the executing of the primary task;
based on a determination that the failure state has occurred and by the second processor circuit or by a third processor circuit of the vehicle, executing a preliminary task that is of a same type as the primary task, wherein the preliminary task is executed with less resources of the vehicle than the primary task; and
based on the determination that the failure state has occurred and an output of the preliminary task, executing, by the second processor circuit, a subsequent task.

2. The method of claim 1, further comprising, based on a determination that no failure state has occurred during the executing of the primary task:
maintaining, by the first processor circuit, the executing of the primary task; and
based on an output of the primary task and by the second processor circuit, controlling execution of the subsequent task.

3. The method of claim 1, wherein the first processor circuit has greater processing capability than the second processor circuit.

4. The method of claim 1, wherein the third processor circuit has greater processing capability than the second processor circuit.

5. The method of claim 1, wherein the primary task and the preliminary task are driven by homogeneous applications, and the primary task is processed by an application that requires more resources of the vehicle than the preliminary task.

6. The method of claim 5, wherein the primary task is executed based on more types of sensor input than the preliminary task.

7. The method of claim 1, wherein the failure state during the executing of the primary task is determined based on:
an operational state of the first processor circuit, and a communication state between the first processor circuit and the second processor circuit.

8. The method of claim 1, further comprising: before the executing of the preliminary task, determining whether both the primary task and the preliminary task are searched for in memory of the vehicle;
assigning the primary task to the first processor circuit and assigning the preliminary task to the second processor circuit or the third processor circuit based on both the primary task and the preliminary task being searched for in the memory; and
executing the primary task.

9. The method of claim 8, wherein the determining of whether both the primary task and the preliminary task are searched for is performed within a predetermined time window after booting of a controller circuit of the vehicle, wherein the controller circuit comprises the first processor circuit, the second processor circuit, and the third processor circuit.

10. The method of claim 1, further comprising: before the executing of the primary task, determining, by the second processor circuit, whether the failure state occurs as an initial condition for executing the primary task;
based on the initial condition indicating that the failure state has occurred and by the second processor circuit or the third processor circuit, initiating execution of the preliminary task; and based on the initial condition indicating that no failure state has occurred and by the first processor circuit, initiating execution of the primary task.

11. A vehicle comprising:
at least one controller circuitry comprising:
a first processor circuit configured to execute a primary task for operations of the vehicle,
a second processor circuit configured to execute a subsequent task, and
a third processor circuit configured to execute a task; and
a memory storing at least one instruction that, when executed by the at least one controller circuitry communicating with the memory, is configured to cause the vehicle to:
execute, by the first processor circuit, the primary task,
determine, by the second processor circuit, whether a failure state has occurred during the execution of the primary task,
based on a determination that the failure state has occurred and by the second processor circuit or the third processor circuit, control a preliminary task to be executed, wherein the preliminary task is of a same type as the primary task, and wherein the preliminary task is executed with less resources of the vehicle than the primary task, and
control the subsequent task to be executed based on an output of the preliminary task.

12. The vehicle of claim 11, wherein the at least one controller circuitry is further configured to, based on a determination that no failure state has occurred during the execution of the primary task:
maintain, by the first processor circuit, the execution of the primary task, and
based on an output of the primary task and by the second processor circuit, control execution of the subsequent task.

13. The vehicle of claim 11, wherein the first processor circuit has greater processing capability than the second processor circuit.

14. The vehicle of claim 11, wherein the third processor circuit has greater processing capability than the second processor circuit.

15. The vehicle of claim 11, wherein the primary task and the preliminary task are driven by homogeneous applications, and the primary task is processed by an application that requires more resources of the vehicle than the preliminary task.

16. The vehicle of claim 15, wherein the primary task is executed based on more types of sensor input than the preliminary task.

17. A vehicle comprising:
a sensor configured to detect an environment of the vehicle;
a driving control circuit configured to control autonomous driving of the vehicle;
a first processor;
a second processor; and
a memory storing at least one instruction that, when executed by the first processor or the second processor communicating with the memory, is configured to cause the vehicle to:
execute, by the first processor, a primary task based on a set of sensor inputs from the sensor, determine, by the second processor, whether a failure occurs during the execution of the primary task,
based on a determination that the failure has occurred, execute, by the second processor, a preliminary task that is of a same type as the primary task, wherein the preliminary task is executed with a reduced set of sensor inputs than the primary task,
execute, by the second processor, a subsequent task based on an output of the preliminary task, and
control, via the driving control circuit and based on the execution of the subsequent task, autonomous driving of the vehicle.

18. The vehicle of claim 17, wherein the at least one instruction that, when executed by the processor communicating with the memory, is configured to cause the vehicle to, based on a determination that no failure has occurred during the execution of the primary task, execute a subsequent task based on an output of the primary task.

19. The vehicle of claim 17, wherein the at least one instruction that, when executed by the processor communicating with the memory, is configured to cause the vehicle to:
execute the primary task using image data, radar data, and lidar data from the sensor, and execute the preliminary task using a subset of the image data and radar data.

20. The vehicle of claim 17, wherein the at least one instruction that, when executed by the processor communicating with the memory, is configured to cause the vehicle to determine the failure based on at least one of:
an operational state of the first processor, or
a communication state between the first processor and the second processor.
